(19) United States
(12) Patent Application Publication
(10) Pub. No.: US 2003/0107237 A1
(43) Pub. Date: Jun. 12, 2003

(54) Door arrangement for motor vehicles

(76) Inventors: Martin Brodt, Renningen (DE); Michael Dyrballa, Waldenbuch (DE); Roland Wendler, Boeblingen (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/290,446

(22) Filed: Nov. 8, 2002

(30) Foreign Application Priority Data
Nov. 9, 2001 (DE) 101 55 220.3

(51) Int. Cl. B60J 5/00

(52) U.S. Cl. 296/146.12

(57) ABSTRACT

A door arrangement for a motor vehicle has a pivotable door and at least one hinge via which the door is articulated on one of its narrow sides on bodywork. Movement of the door between its open and closed positions proceeds, under automatic control, about two axes of rotation running approximately parallel through the hinge. During opening of the door, in a first movement stage, the hinge-side end region of the door is guided in a pivoting/sliding manner out of the door opening and the lock-side end region of the door is guided in a pivoting/sliding manner by guide elements along the door opening into a release position. Thereafter, the axis of rotation moved together with the door is shifted out of the door opening, and the door can be pivoted exclusively about the shifted axis of rotation in a second movement stage.

This application claims the priority of German application 101 55 220.3, filed Nov. 9, 2001, the disclosure of which is expressly incorporated by reference herein.

### BACKGROUND AND SUMMARY OF THE INVENTION

This invention relates to a door arrangement for a motor vehicle including a pivotable door which, when closed, is sealed off with respect to a bodywork frame bounding a door opening via a sealing arrangement, at least one hinge via which the door is articulated on one of its narrow sides on the frame, and a lock by which the door, when closed, can be locked on its lock side. Movement of the door between its open and closed positions proceeds, under automatic control, about two axes of rotation running approximately parallel through the hinge. A first of these axes of rotation is fixed on the vehicle, and a second of the axes of rotation is moved together with the door.

A door arrangement of this type is already known from German patent publication DE 19754417 A1. This known door arrangement comprises a door which can be moved about two approximately parallel axes: a first axis of rotation which is fixed on the vehicle and a second axis of rotation which is moved together with the door. A control lever articulated on the door and bodywork controls the sequence of movement during opening and closing of the door, as a result of which a pivoting/sliding movement of the same is produced.

As a consequence of the hinge design provided for controlling the movement of the door, the opening angle of the door cannot readily be increased to an angle of 90° or more. In addition, the door is only insignificantly displaced longitudinally in the first opening movement phase. However, if there is an overlap between the closed door and adjacent bodywork components, a greater longitudinal displacement in this opening movement phase may be required structurally in order to overcome the overlap.

One object of this invention is to further develop a door arrangement for motor vehicles of the type mentioned above so that the suitability for opening the door to angles of more than 90° is improved and the structural freedom in designing the door opening is significantly increased.

This object is achieved according to the invention by features permitting movement of the door during the opening process to proceed in consecutive stages. In a first movement stage, a hinge-side end region of the door is guided in a pivoting/sliding manner out of the door opening, and a lock-side end region of the door is guided in a pivoting/sliding manner by guide elements along the door opening into a release position. After this, the second axis of rotation is shifted out of the door opening, and the door can be pivoted exclusively about the shifted second axis of rotation in a second movement stage. Further features refining the invention in an advantageous manner are reflected in the claims.

One advantage obtained by the invention is that the closed door can be overlapped in its lock-side end region by an adjacent bodywork component as a function of the path of displacement of the guide means controlling the door in this end region. The clearance for opening the door about an angle of more than 90° is produced by releasing the lock-side end region of the door in conjunction with the shifting of the door-side axis of rotation out of the door opening during the first movement stage in the opening process.

In order to facilitate handling, the door can be moved via a drive arrangement in the first movement stage or in both movement stages. A compact construction and a space-saving arrangement of the drive can be obtained by means of rotating drive elements. A particularly simple and reliable drive can comprise a hydraulic system having two working cylinders which are known per se. Irrespective of the type of movement of the drive elements, it is advantageous for the sequence control of the movement stages if the door is moved in its first and second movement stages via a respectively assigned drive element.

The closed door can be reliably fastened via an upper pair and a lower pair of guide means which are arranged on opposite sides of the lock-side end region of the door. For manual emergency opening of the door, the guide means of both pairs of guide means can be released from each other when the door is closed. This is of particular importance in terms of safety aspects for motor cars which have side doors which are exclusively guided in a pivoting/sliding manner.

Emergency actuation of the door can take place in a similar manner to the opening actuation of conventional, pivotable doors, for example by means of a door handle. This ensures that an emergency helper can open the door from the outside in a known manner. In the simplest case, the pairs of guide means can be designed for this purpose as overload couplings which release the door as soon as the latter is loaded towards pivoting open by means of a predetermined level of force.

In order to achieve a cost- and weight-saving construction, the door can be articulated on the frame by means of a central hinge.

The closed door can be overlapped in its lock-side end region by a second door which can be pivoted in an opposite direction thereto. It is possible for first and second doors to be opened and closed independently of each other. This overlap is particularly advantageous between front and rear side doors in vehicles without B-pillars, since the crush resistance of the side walls can thereby be increased.

In order to ensure reliable locking of the second, pivotable door, in the case of a vehicle without B-pillars, the door, when closed, can be locked via a conventional rotary-latch lock with a closing bracket which is arranged on the end side of the first door. So that the second door is also held reliably in its closed position when the first door is open, the second door can be fastened on the sill of the bodywork via an additional locking device.

The invention also relates to a door opening process.

An exemplary embodiment of the invention will be explained in greater detail below with reference to the drawings.

### BRIEF DESCRIPTION OF THE DRAWINGS

FIG. 1 is a side view of bodywork of a motor vehicle with two side doors, which move in opposite directions, in the closed state,

FIG. 2 shows the rear side door according to FIG. 1 together with the connection to the front door in a horizontal section,

FIG. 3 shows the door hinge of the rear door with working cylinders and guide means,

FIG. 4 is a schematic diagram of the sequence of movement during opening of the rear door, and

FIG. 5 shows the side wall according to FIG. 1 with the doors completely open.

### DETAILED DESCRIPTION OF THE INVENTION

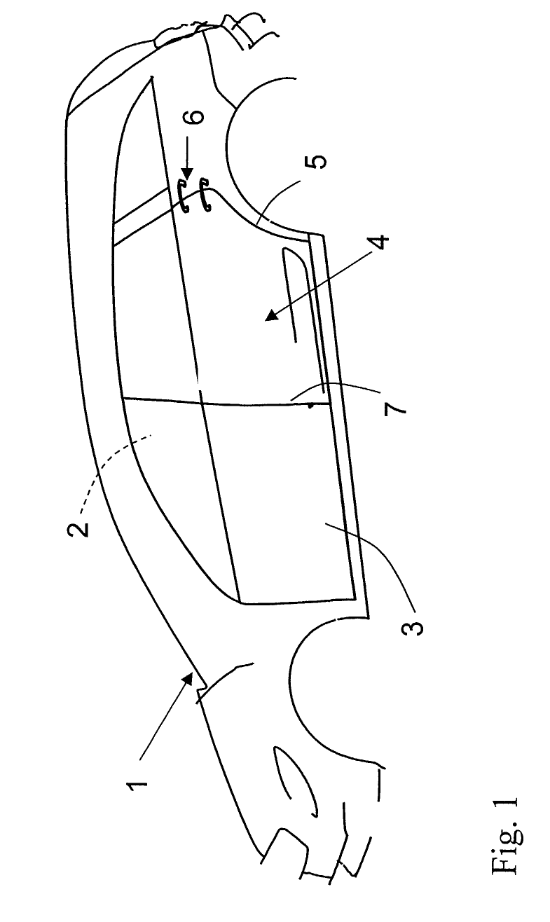

Only the lateral part of the bodywork with a door opening 2 bounded by a bodywork frame formed from the A-pillar, C-pillar, sill and lateral roof frame of a motor car 1 is illustrated in FIG. 1. The continuous door opening 2 of the side wall, which is without a B-pillar, is closed by a front side door 3 and a rear side door 4 which are directly adjacent to each other and end flush with the side wall.

The front door 3 is articulated on the A-pillar of the bodywork via a customary door hinge and is therefore mounted pivotably. The rear door 4 is articulated on its rear hinge side 5 on the C-pillar of the bodywork by means of a central hinge 6 and is additionally connected in the vicinity of its front lock side 7 to the bodywork via guide means.

The closed, front door 3 is locked at its rear end side by means of a customary rotary-latch lock with a closing bracket (not shown) which is arranged on the lock side 7 of the rear door 4. An additional, releasable locking device (not illustrated) is arranged on the lower narrow side of the front door 3, in the rear end region, and is used to fasten the closed door 3 on the sill. The closed front door 3 and rear door 4 are sealed off from the bodywork at the respective door circumference via sealing arrangements.

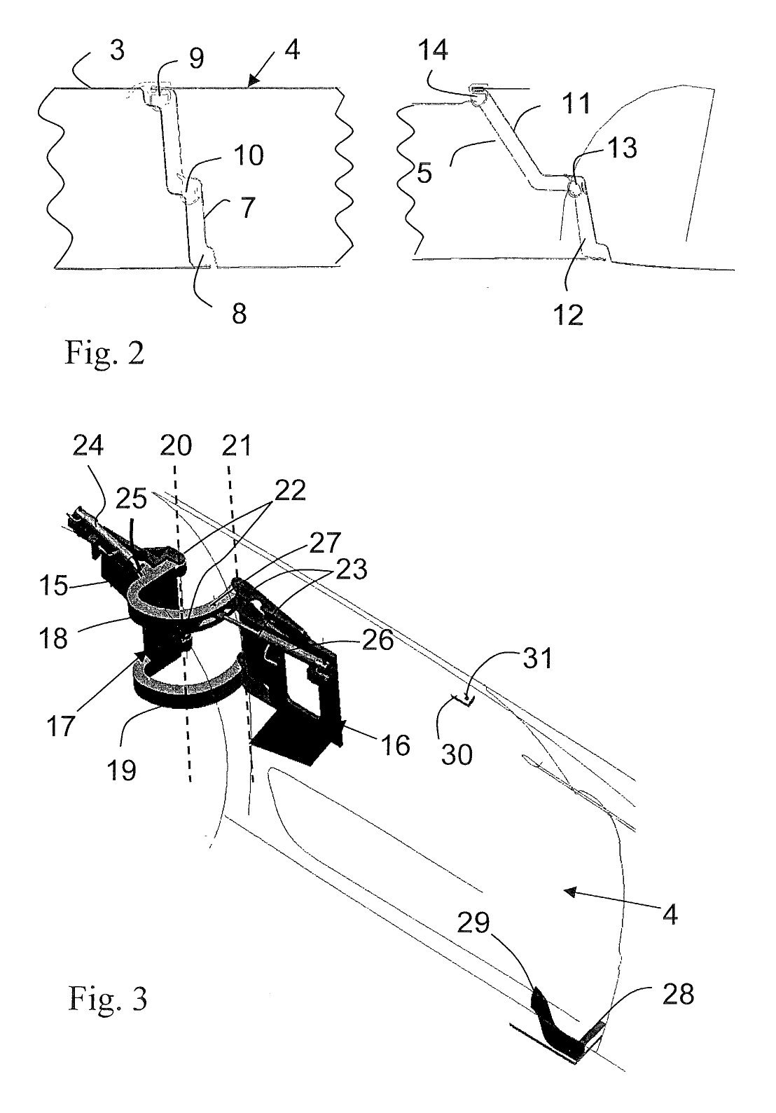

FIG. 2 shows a horizontal section through the rear door 4. The rear end side of the front door 3 and the lock side 7 of the rear door 4 bound a front door gap 8 which is sealed off via an inner sealing profile 9 and an outer sealing profile 10. The two sealing profiles 9 and 10 of rubber-elastic material are fastened to the lock side 7 of the rear door 4 and extend over the entire height of the door gap 8. The inner sealing profile 9 bears transversely to the door opening 2 against a step of the end side of the front door 3 and overlaps the latter on its inner side with a sealing finger or a sealing lip.

The rear end side of the front door 3 has, on the outside, an end region which is bent approximately at right angles and overlaps a recoilingly arranged region of the lock side 7 of the rear door 4, while an end region which is bent approximately at right angles and overlaps a recoilingly arranged region of the end side of the front door 3 is formed on the lock side 7 of the rear door 4, on the inside.

The hinge side 5 of the rear door 4 bounds, by means of a mating surface 11 of the C-pillar of the bodywork, a rear door gap 12 which is sealed off over its entire height by means of an outer sealing profile 13 and an inner sealing profile 14. The two sealing profiles 13 and 14 made of rubber-elastic material are fastened to the mating surface 11 of the C-pillar. The hinge side 5 has, on the outside, an end region which is bent approximately at right angles and overlaps a recoilingly arranged region of the mating surface 11.

In FIG. 3, the central hinge 6 on the rear door 4 is illustrated. The hinge 6 comprises a bodywork-side console 15 and a door-side console 16 which are connected to each other in an articulated manner by a lever arm 17 curved in the shape of a U.

The lever arm 17 of the hinge comprises an upper limb 18 and a lower limb 19 having a rectangular cross section. The limbs have the same profile which is curved in the shape of a U and is open towards the exterior of the vehicle, and are connected to each other in the vicinity of their rear end regions by a rectangular plate.

The front and rear end regions of the upper limb 18 and the lower limb 19 are of cylindrical design. The rear cylindrical end regions of upper limb 18 and lower limb 19 are connected to the bodywork-side console 15 in a manner such that they can rotate about a first axis of rotation 20 which is fixed on the vehicle and runs approximately parallel to the vertical axis. The front cylindrical end regions of upper limb 18 and lower limb 19 are connected to the door-side console 16 in a manner such that they can rotate about a second axis of rotation 21 which is moved together with the door and runs appropriately parallel to the vertical axis.

The bodywork-side console 15 is fastened to the inner side of the C-pillar somewhat below the flange edge. The console 15, which is of plate-like design, comprises a rear rectangular region which is adjoined by a region which widens trapezoidally towards the door opening 2. On the upper and lower end regions of its front end side, the console 15 has receiving consoles 22 in which the upper limb 18 and the lower limb 19 of the lever arm 17 are mounted in a manner such that they can rotate about the axis of rotation 20 fixed on the vehicle, by means of bolts.

The door-side console 16 is arranged on the inner side of the door 4, in the vicinity of its hinge side 5, at approximately the same height as the bodywork-side console 15. The door-side console 16 is designed as a rectangular plate having a rectangular opening in its central region. Two ribs in each case along the upper and lower end region of the console 16 taper out towards the rear door gap 12 as receiving consoles 23 in which the cylindrical front end regions of the lever arm 17 are arranged and are held in a manner such that they can rotate about the door-side axis of rotation 21, by means of bolts. The door 4 is driven by two working cylinders. The first working cylinder 24 controls the movement of the door 4 about the axis of rotation 20 fixed on the vehicle. The cylinder-side end region of the working cylinder 24 is connected to a rear, bent end region of the bodywork-side console 15 in a manner such that it can rotate about the vertical axis, by means of a bolt. The end of the piston rod of the cylinder 24 is fitted in a manner such that it can rotate about the vertical axis, by means of a further bolt, to a fastening eyelet 25 which protrudes from the upper limb 18 of the lever arm 17 and is arranged in the rear region of the limb 18 at a distance from the axis of rotation 20 which is fixed on the vehicle.

The second working cylinder 26 controls the movement of the door 4 about the door-side axis of rotation 21. The cylinder-side end region of the second working cylinder 26 is fastened to a front, bent end region of the door-side console 16 in a manner such that it can rotate about the vertical axis, by means of a bolt. The end of the piston rod of the second working cylinder 26 engages on a fastening point 27 on the front region of the upper limb 18, which region is arranged at a distance from the door-side axis of rotation 21. The end of the piston rod engages in an opening, which is designed as a longitudinal slot, of the upper limb 18 and is fastened in a manner such that it can rotate about the vertical axis, by means of a bolt. In order to make the opening small and therefore to reduce its influence on the strength of the component, the opening has, perpendicular with respect to the vertical axis, a cross section which widens trapezoidally towards the second working cylinder 26.

The first working cylinder 24 and the second working cylinder 26 are operated via a hydraulic actuating system known from folding-top drives.

A guide roller 28 is fitted on a protruding securing means on the inner side of the door 4, in a lower end region in the vicinity of the lock side 7. The guide roller is guided at its circumference in a guide rail 29 which is fastened to the sill of the bodywork. The guide rail 29 has a rectangular hollow cross section in which the guide roller 28 is arranged and runs, the securing means of the guide roller 28 engaging in the guide rail 29 via an opening on the outer longitudinal side thereof. The guide rail 29 runs in a curved manner along a front partial section of the door opening 2 and obliquely outwards. The closed door 4 is held transversely to the door opening 2 in the front end region of the guide rail 29 via the guide roller 28. In the rear end region of the guide rail 29 a rectangular opening in its outer longitudinal side enables the guide roller 28 to be shifted out of the guide rail 29 when the door 4 is displaced longitudinally.

A short holding rail 30 is fastened to the lateral roof frame of the bodywork, in the vicinity of the lock side of the closed door 4. The holding rail 30 comprises an inner limb and a short outer limb which encloses a circular hollow cross section widening trapezoidally to the rear. When the door 4 is closed, a cylindrical holding bolt 31 (not illustrated) of the door 4 engages in the hollow cross section of the holding rail 30, so that the door 4 is additionally held on its lock side 7 in the upper end region.

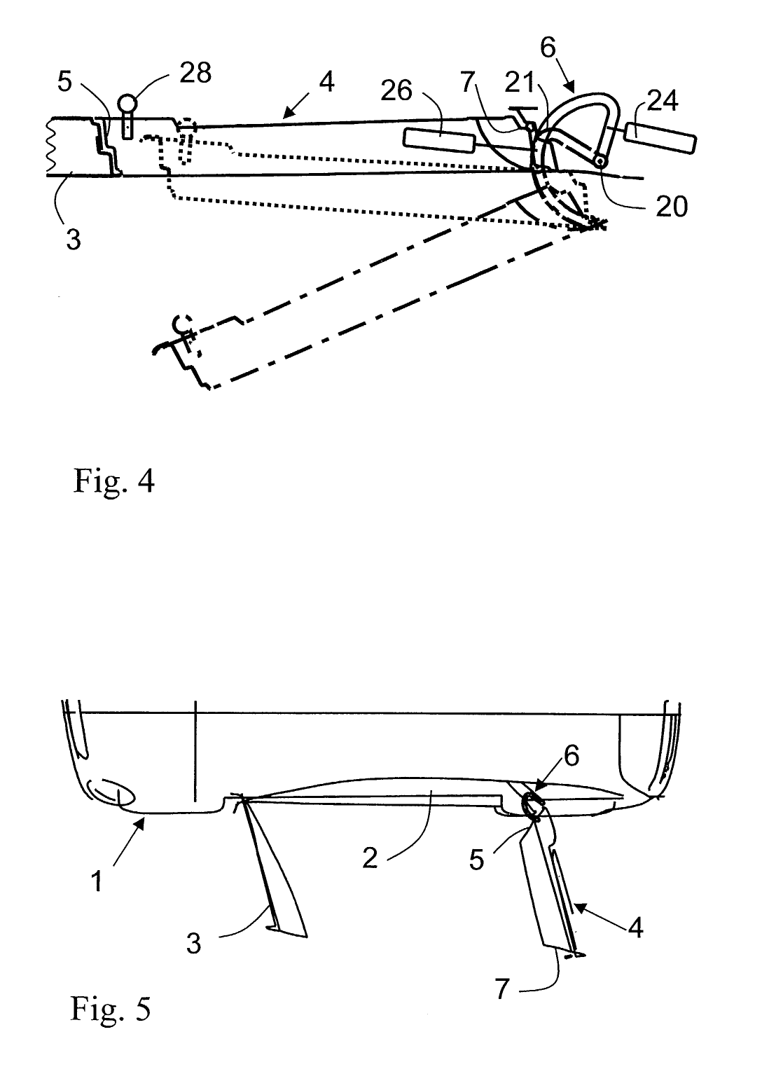

FIG. 4 illustrates, in a schematic diagram, the sequence of movement when opening the rear side door 4. The solid lines show the closed position of the door 4. The door-side axis of rotation 21 of the hinge 6 is arranged within the door opening 2. When the door is closed, the guide rail 28 is held transversely to the door opening 2 in the front end region of the bodywork-side guide rail 29. The first working cylinder 24 is in its maximally retracted position.

The opening movement of the door 4 proceeds under sequence control in two consecutive stages. In the first movement stage, the door 4 is moved in a pivoting/sliding manner as far as a release position, which is illustrated in FIG. 4 by dashed lines. For this purpose, the first working cylinder 24 is expanded, as a result of which the hinge 6 and the hinge side 5 of the door 4 are pivoted out of the door opening 2 about the axis of rotation 20 fixed on the vehicle. During the entire, first movement stage, the second working cylinder 26 is connected in an unpressurized manner, i.e. can be displaced with little resistance.

Since, when the door 4 is closed, the axis of rotation 20 fixed on the vehicle and the door-side axis of rotation 21 lie in a plane which runs approximately parallel to the door opening 2, a tangential displacement running outwards approximately perpendicular to the door opening 2 is produced for the hinge side 5 at the beginning of the first movement stage. The lock side 7 of the door 4, which is arranged somewhat in front of the guide roller 28, is correspondingly pivoted at a tangent, which runs inwards approximately perpendicular to the door opening 2, about the axis of rotation of the guide roller 28, which is held in the front end region of the guide rail 29, at the beginning of the first movement stage. In the process, the sealing profiles 9 and 10, which are fastened to the lock side 7, lift off the front door 3 and the closing bracket on the rear door 4 is shifted out of the rotary-latch lock on the front door 3, which lock has already been unlocked automatically by being activated by the actuating system.

In the further course of the first movement stage, the lock side 7 of the rear door 4 is guided in a sliding manner along the guide rail 29 into the release position. The holding bolt 31, which is moved together with the door 4, is displaced out of the forked opening of the holding rail 30.

In the release position, the door-side axis of rotation 21 is shifted out of the door opening 2. The guide roller 28 of the door 4 is arranged in that front end region of the guide rail 29 in which an opening for disengaging the guide roller is situated. In the release position, the first working cylinder 24 takes up its maximally expanded end position, after which the second movement stage is initiated.

In the second movement stage, the axis of rotation 20 fixed on the vehicle is held in its position by means of the first working cylinder 24 which is pressurized during the entire second movement stage. The second working cylinder 26 is expanded, as a result of which the door 4 is moved in a pivoting manner about the door-side axis of rotation 21 into its opened position which is illustrated in FIG. 4 by dash-dotted lines.

In the opened position of the door 4, the second working cylinder 26 has taken up its maximally expanded end position.

In FIG. 5, the lateral part of the bodywork of the motor car 1 is illustrated with front door 3 and rear door 4 open. The opened rear door 4 encloses an opening angle of approximately 110° with the side wall. Even greater opening angles can be realized by a changed arrangement of the axes of rotation 20 and 21 and by an enlargement of the stroke of the working cylinders 24 and 26.

During closure of the rear door 4 the movement stages described are passed through in reverse sequence. The door 4 is first of all moved in a pivoting manner about the door-side axis of rotation 21, by means of the second working cylinder 26, into the release position in which the guide roller 28 of the door 4 engages in the bodywork-side guide rail 29. Subsequently, the second working cylinder 26 is depressurized and the door 4 is moved in a pivoting/sliding manner into its closed position by means of contraction of the first working cylinder 24.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

We claim:

1. A door arrangement for a motor vehicle, comprising:
a pivotable door which, when closed, is sealed off with respect to a bodywork frame bounding a door opening via a sealing arrangement,
at least one hinge via which the door is articulated on one of its narrow sides on the frame, and
a lock by which the door, when closed, can be locked on its lock side,
wherein movement of the door between its open and closed positions proceeds, under automatic control, about two axes of rotation running approximately parallel through the hinge, a first of said axes of rotation being fixed on the vehicle and a second of said axes of rotation being moved together with the door,
wherein the movement of the door during the opening process proceeds in a first movement stage, in which a hinge-side end region of the door is guided in a pivoting/sliding manner out of the door opening and a lock-side end region of the door is guided in a pivoting/sliding manner by guide elements along the door opening into a release position, after which the second axis of rotation is shifted out of the door opening, and a second movement stage, in which the door can be pivoted exclusively about the shifted second axis of rotation.

2. The door arrangement according to claim 1, wherein the door is moved via a drive at least during said first movement stage.

3. The door arrangement according to claim 2, wherein the drive has at least one rotating drive element.

4. The door arrangement according to claim 2, wherein the drive has at least one length-changeable drive element.

5. The door arrangement according to claim 2, wherein respective drive elements are assigned to the first and second movement stages.

6. The door arrangement according to claim 5, wherein the drive elements are two working cylinders of a hydraulic system.

7. The door arrangement according to claim 1, wherein an outer side of the pivotable door, when closed, is overlapped in its end region close to the lock by an adjacent bodywork component.

8. The door arrangement according to claim 7, wherein the pivotable door defines a first door, and the bodywork component is a second door which can be pivoted in a direction opposite to that in which the first door can be pivoted.

9. The door arrangement according to claim 8, wherein the first door and the second door, when closed, can be locked to each other, and wherein the second door, when closed, can be fastened on the bodywork frame via an additional locking device.

10. The door arrangement according to claim 1, wherein the guide elements can be released from each other when the door is closed for emergency opening thereof.

11. The door arrangement according to claim 1, wherein the closed door is held at opposite end zones of its lock-side end region via holding elements and said guide elements.

12. The door arrangement according to claim 1, wherein the door is articulated on the frame by a central hinge, the hinge having a lever arm curved approximately in the shape of a U between the axes of rotation.

13. A process for opening a door of a door arrangement for a motor vehicle, which door is movable between open and closed positions, under automatic control, about two axes of rotation running approximately parallel through a door hinge, a first of said axes of rotation being fixed on the vehicle and a second of said axes of rotation being moved together with the door, comprising:
guiding a hinge-side end region of the door in a pivoting/sliding manner out of a door opening and a lock-side end region of the door in a pivoting/sliding manner along the door opening into a release position in a first movement stage,
shifting the second axis of rotation out of the door opening, and
pivoting the door exclusively about the shifted second axis of rotation in a second movement stage.

14. A door arrangement for a motor vehicle, comprising:
a pivotable door which, when closed, is sealed off with respect to a bodywork frame bounding a door opening,
at least one hinge via which the door is articulated on one of its narrow sides on the frame, and
a lock by which the door, when closed, can be locked on its lock side,
wherein movement of the door between its open and closed positions proceeds about two axes of rotation running approximately parallel through the hinge, a first of said axes of rotation being fixed on the vehicle and a second of said axes of rotation being moved together with the door,
wherein the movement of the door during the opening process proceeds in a first movement stage, in which a hinge-side end region of the door is guided out of the door opening and a lock-side end region of the door is guided along the door opening into a release position, after which the second axis of rotation is shifted out of the door opening, and a second movement stage, in which the door can be pivoted exclusively about the shifted second axis of rotation.

15. The door arrangement according to claim 14, wherein the door is moved via a drive at least during said first movement stage.

16. The door arrangement according to claim 15, wherein the driven has at least one rotating drive element.

17. The door arrangement according to claim 15, wherein the drive has at least one length-changeable drive element.

18. The door arrangement according to claim 15, wherein respective drive elements are assigned to the first and second movement stages.

19. The door arrangement according to claim 18, wherein the drive elements are two working cylinders of a hydraulic system.

20. The door arrangement according to claim 14, wherein an outer side of the pivotable door, when closed, is overlapped in its end region close to the lock by an adjacent bodywork component.

21. The door arrangement according to claim 20, wherein the pivotable door defines a first door, and the bodywork component is a second door which can be pivoted in a direction opposite to that in which the first door can be pivoted.

22. The door arrangement according to claim 21, wherein the first door and the second door, when closed, can be locked to each other, and wherein the second door, when closed, can be fastened on the bodywork frame via an additional locking device.

23. The door arrangement according to claim 14, wherein the lock-side end region of the door is guided in a pivoting/sliding manner by guide elements, and wherein the guide elements can be released from each other when the door is closed for emergency opening thereof.

24. The door arrangement according to claim 14, wherein the closed door is held at opposite end zones of its lock-side end region via holding elements and guide elements.

25. The door arrangement according to claim 14, wherein the door is articulated on the frame by a central hinge, the hinge having a lever arm curved approximately in the shape of a U between the axes of rotation.
